(19) United States
(12) Patent Application Publication
(10) Pub. No.: US 2023/0249496 A1
(43) Pub. Date: Aug. 10, 2023

(54) WHEEL HUB SEAL

(71) Applicant: Consolidated Metco, Inc., Vancouver, WA (US)

(72) Inventors: Connor Regan, Vancouver, WA (US); Xin Yu, Vancouver, WA (US); Gregg Smith, Vancouver, WA (US)

(21) Appl. No.: 18/166,727

(22) Filed: Feb. 9, 2023

Related U.S. Application Data
(60) Provisional application No. 63/308,362, filed on Feb. 9, 2022.

(51) Int. Cl. B60B 27/00; F16C 33/72

(52) U.S. Cl. CPC B60B 27/0073; F16C 33/723; F16C 33/726; F16C 2326/02

(57) ABSTRACT

In one aspect, an apparatus for retaining lubricant in a wheel hub assembly, the wheel hub assembly including a wheel hub and a spindle nut for securing the wheel hub to a vehicle spindle. The apparatus includes an annular lubricant seal, a mounting portion of the lubricant seal to be mounted to the wheel hub, a central opening of the lubricant seal to receive a running surface of the spindle nut, and a sealing portion of the lubricant seal extending around the central opening of the lubricant seal. The sealing portion is configured to form a dynamic seal with the running surface of the spindle nut and keep the lubricant from escaping between the sealing portion of the lubricant seal and the running surface of the spindle nut as the wheel hub rotates around the vehicle spindle.

### CROSS-REFERENCE TO RELATED APPLICATION

This application claims benefit of U.S. Provisional Application No. 63/308,362 filed Feb. 9, 2022, which is hereby incorporated herein by reference in its entirety.

### FIELD

This disclosure relates to wheel hub assemblies for vehicles and, more particularly, to wheel hub assemblies having seals that protect bearing assemblies of the wheel hub assemblies.

### BACKGROUND

Wheel hub assemblies are used to connect wheels to axles of vehicles. Some axles are driven axles, which include spindles at the ends of the axle and drive shafts such as semi-shafts in the spindles. Wheel hub assemblies used with driven axles include bearing assemblies to rotatably mount the wheel hub assemblies to the spindles. The wheel hub assemblies are connected to the semi-shafts of the axles such that rotation of the semi-shafts causes rotation of the wheel hub assemblies. The wheel hub assemblies are filled with a lubricant, such as oil, for lubricating the bearing assemblies of the wheel hub assemblies.

In some vehicles, the bearing assemblies of the wheel hub assemblies are in fluid communication with an interior of the associated axle such that lubricant may travel between the bearing assemblies and the interior of the axle. The lubricant may thereby lubricate both the bearings of the wheel hub assemblies and the components in the interior of the axle. One shortcoming with these systems is that, over time, leakage of lubricant into the axle may reduce the volume of lubricant in the wheel hub assemblies to an undesirable level and shorten the lifespan of the wheel hub assemblies.

### SUMMARY

In one aspect of the present disclosure, an apparatus is provided for retaining lubricant in a wheel hub assembly, the wheel hub assembly including a wheel hub and a spindle nut for securing the wheel hub to a vehicle spindle. The vehicle spindle may be a driven axle or a non-driven axle. The apparatus includes an annular lubricant seal, a mounting portion of the lubricant seal to be mounted to the wheel hub, a central opening of the lubricant seal to receive a running surface of the spindle nut, and a sealing portion of the lubricant seal extending around the central opening of the lubricant seal. The sealing portion is configured to form a dynamic seal with the running surface of the spindle nut and keep the lubricant from escaping between the sealing portion of the lubricant seal and the running surface of the spindle nut as the wheel hub rotates around the vehicle spindle. The lubricant seal retains the lubricant in the wheel hub assembly rather than permitting the lubricant to escape into the interior of the vehicle spindle. In this manner, the lubrication of the wheel hub of a vehicle may be independent of the lubrication of the drive axle of the vehicle, thereby permitting a lower lubricant fill level of the drive axle to be used which reduces the frictional losses of the axle and weight of the vehicle.

The present disclosure also provides a wheel hub assembly that includes a wheel hub, a bearing assembly for rotatably supporting the wheel hub on a vehicle spindle, and a spindle nut for securing the wheel hub and the bearing assembly to the vehicle spindle. The wheel hub assembly further includes a lubricant seal having a mounting portion to be secured to the wheel hub so that the lubricant seal rotates with the wheel hub. The lubricant seal has a sealing portion configured to sealingly engage a running surface of the spindle nut. The lubricant seal and running surface of the spindle nut cooperate to maintain the lubricant in the wheel hub assembly. In this manner, the wheel hub assembly may have a different lubricant than is used in the associated drive axle of the vehicle.

In accordance with another aspect, a wheel hub assembly is provided that includes a wheel hub having an interior, a bearing assembly for rotatably connecting the wheel hub to a vehicle spindle of the vehicle, and a spindle nut for securing the wheel hub and the bearing assembly to the vehicle spindle. The wheel hub assembly further includes a lubricant seal system configured to extend between a first cavity of the interior of the wheel hub that contains the bearing assembly and a second cavity of the interior of the wheel hub during operation of the vehicle. The lubricant seal system is configured to keep lubricant in the first cavity from escaping into the second cavity. The wheel hub assembly further includes a vent configured to relieve air pressure in the first cavity by venting air in the first cavity to the second cavity. During operation of the vehicle, the temperature of the air in the first cavity may increase due to environmental temperature and the friction between the components of the bearing assembly. The increase in air temperature produces a corresponding increase in the air pressure in the first cavity. The vent permits air to escape and relieve air pressure before the increased air pressure may damage the lubricant seal system or another seal of the wheel hub assembly and causes lubricant loss and damage to the bearing assembly. In some embodiments, the vent opens once the air pressure in the first cavity reaches a predetermined pressure to permit air pressure to escape and closes once the air pressure falls below the predetermined pressure. As one example, the vent may include a slit formed in a resilient layer of material of a lubricant seal of the lubricant seal system.

The present disclosure also provides a lock washer for a wheel hub assembly. The lock washer includes an annular body for being sandwiched between components of the wheel hub assembly. The annular body includes a central opening sized to receive a vehicle spindle, a key configured to engage a keyway of the vehicle spindle to inhibit rotation of the annular body around the vehicle spindle, and a plurality of locking openings to receive a protrusion of a lock ring. The annular body further includes an air vent of the annular body configured to permit pressurized air from adjacent one of the components to travel through the air vent and into the keyway of the vehicle spindle.

In yet another aspect of the present disclosure, a method is provided for installing a wheel hub on a vehicle spindle. The method includes positioning a wheel hub on the vehicle spindle and engaging a spindle nut with the vehicle spindle to rotatably capture the wheel hub on the spindle. The method includes advancing a lubricant seal in an inboard direction in a central bore of the wheel hub to position a sealing portion of the lubricant seal in engagement with a running surface of the spindle nut. A mounting portion of the lubricant seal is secured to the wheel hub so that the lubricant seal is rotatable with the wheel hub about the vehicle spindle while the lubricant seal remains engaged with the running surface of the spindle nut. In this manner, the lubricant seal may be installed in the wheel hub after the wheel hub has been mounted to a vehicle spindle. The lubricant seal is generally outboard of the spindle nut and bearings of the wheel hub which permits the lubricant seal to be inspected and replaced without removing the entire wheel hub from the vehicle spindle.

### BRIEF DESCRIPTION OF THE DRAWINGS

FIG. 1 is a cross-sectional view of wheel ends and a drive axle with semi-shafts of the drive axle removed to illustrate lubricant fill levels of the drive axle.

FIG. 2 is a cross-sectional view of one of the wheel ends of FIG. 1 showing a wheel hub assembly of the wheel end.

FIG. 3 is a cross-sectional view of a portion of the wheel end of FIG. 2, FIG. 3 showing a semi-shaft connected to the wheel hub assembly and a lubricant seal system of the wheel hub assembly according to a first embodiment.

FIG. 4 is a cross-sectional view of a portion of the wheel end of FIG. 2, FIG. 4 showing a semi-shaft connected to the wheel hub assembly and a lubricant seal system according to a second embodiment.

FIG. 5 is a cross-sectional view of a portion of the wheel end of FIG. 2, FIG. 5 showing a semi-shaft connected to the wheel hub assembly and a lubricant seal system according to a third embodiment.

FIG. 6 is a cross-sectional view of a portion of the wheel end of FIG. 2, FIG. 6 showing a semi-shaft connected to the wheel hub assembly and a lubricant seal system according to a fourth embodiment.

FIG. 7 is a cross-sectional view of a portion of the wheel end of FIG. 2, FIG. 7 showing the wheel end having a lubricant seal system according to a fifth embodiment and showing a tool used to insert a sealing body of the lubricant seal system.

FIG. 8 is a cross-sectional view of a portion of the wheel end of FIG. 2, FIG. 8 showing a semi-shaft connected to the wheel hub assembly and a lubricant seal system according to a sixth embodiment.

FIG. 9 is a perspective view of a seal of the lubricant seal system of FIG. 8.

FIG. 10A is a cross-sectional view taken across line 10A-10A in FIG. 9 showing an air vent of the seal.

FIG. 10B is a cross-sectional view taken across line 10B-10B in FIG. 9 showing an air vent of the seal.

FIG. 10C is a cross-sectional view taken across line 10C-10C in FIG. 9 showing an air vent of the seal.

FIG. 10D is a cross-sectional view taken across line 10D-10D in FIG. 9 showing an air vent of the seal.

FIG. 11 is a cross-sectional view of a portion of the wheel end of FIG. 2, FIG. 11 showing a semi-shaft connected to the wheel hub assembly and the wheel hub assembly having a lubricant seal system according to a seventh embodiment.

FIG. 12 is a perspective view of a lock washer of the wheel hub assembly of FIG. 11, FIG. 11 showing a radial groove in a face of the lock washer that permits air to vent around the seal system of FIG. 11.

### DETAILED DESCRIPTION

A lubricant seal system is provided herein for sealing lubricant within a wheel hub assembly. The seal system inhibits lubricant from flowing out of the wheel hub assembly to the drive axle. By retaining lubricant within the wheel hub assembly, lubricant may be replenished less frequently. For example, the wheel hub assembly may not receive lubricant from the drive axle as in existing systems. As a result, the volume of lubricant within the drive axle can be reduced which may reduce the frictional losses and weight of the drive axle, which improves vehicle efficiency, and reduces the cost of filling and replacing the fluid in the drive axle.

Another advantage of the seal system is that the lubricant maintained in the wheel hub assembly by the seal system may be different than the lubricant in the drive axle. For example, the drive axle may utilize a lower-viscosity lubricant while the wheel hub assembly utilizes a higher-viscosity lubricant. The seal system keeps the higher-viscosity lubricant in the wheel hub assembly rather than permitting the higher-viscosity lubricant to escape.

In one embodiment, the seal system includes a seal configured to be secured to a wheel hub body of the wheel hub assembly. For example, the seal may include a rib or flange sized to be received in a groove of the wheel hub body and/or clamped between the wheel hub body and a flange of the associated semi-shaft. The seal system further includes a spindle nut configured to threadingly engage the spindle supporting the wheel hub assembly. The spindle nut may have a unitary, one-piece construction or may comprise an assembly of a spindle nut body with threads and a sleeve attached to the spindle nut body. The spindle nut has a running surface and the seal has a sealing portion that sealingly engages the running surface of the spindle nut as the wheel hub body rotates about the spindle during operation of the associated vehicle. The sealing engagement between sealing portion of the seal and the running surface of the spindle nut forms a dynamic seal therebetween to retain lubricant within the wheel hub assembly. In one embodiment, the spindle nut includes a threaded body to engage the spindle and a sleeve configured to inhibit lubricant from flowing through a keyway of the spindle.

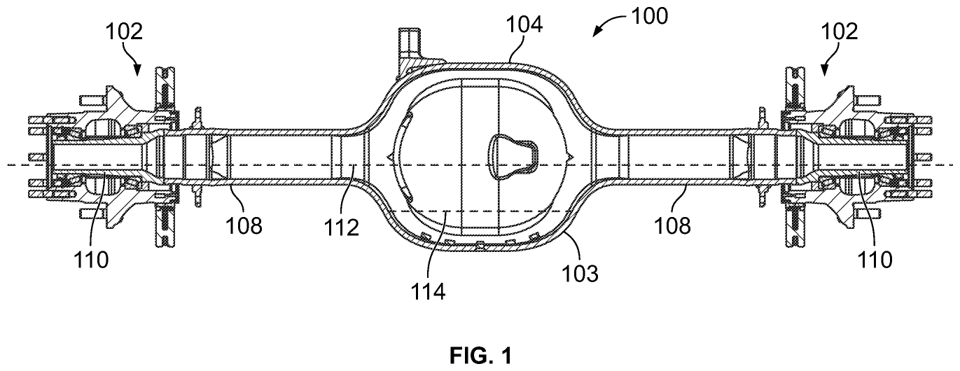

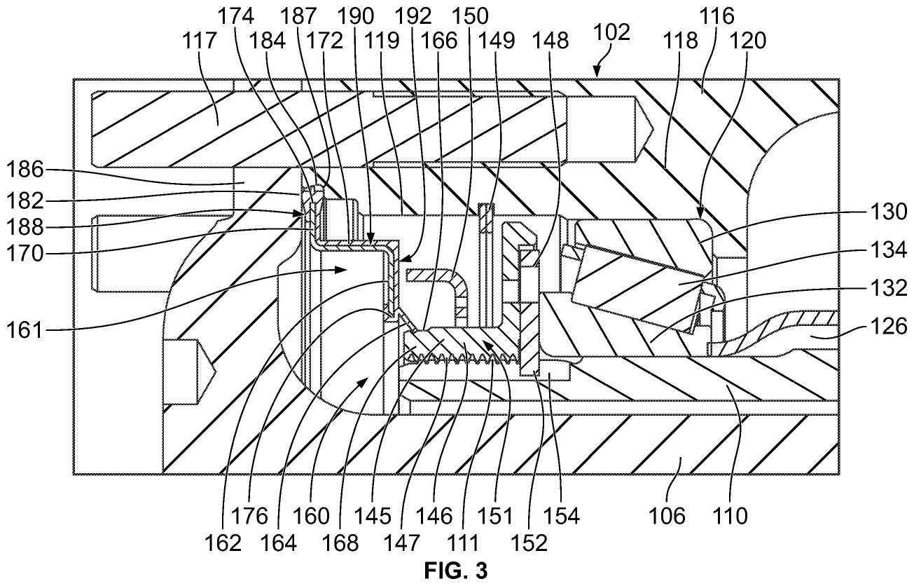

With respect to FIG. 1, a drive axle 100 of a vehicle is provided having wheel hub assemblies 102 attached to the ends of the drive axle 100. The drive axle 100 includes a housing 103 having a differential housing portion 104 for containing a differential gear system connected to semi-shafts 106 (see FIG. 3) that extend through shaft housing portion 108 to the wheel hub assemblies 102. The ends of the shaft housing portions 108 include spindles 110 to which the wheel hub assemblies 102 are mounted and rotate about. The housing 103 contains lubricant for lubricating the differential gear system. With reference to FIG. 1, in some prior drive axles, the housing of the drive axle is filled with lubricant to up to the line 112 to ensure that the lubricant travels along the shaft housing portions 108 to replenish the lubricant in the wheel hub assemblies 102. As described in further detail below, using the seal systems described herein, the fill level of lubricant in the housing 103 may be reduced for example to the line 114 because the seal systems of the wheel hub assemblies 102 retain lubricant within the wheel hub assemblies 102 rather than relying on lubricant from within the housing 103 to lubricate bearing assemblies of the wheel hub assemblies 102.

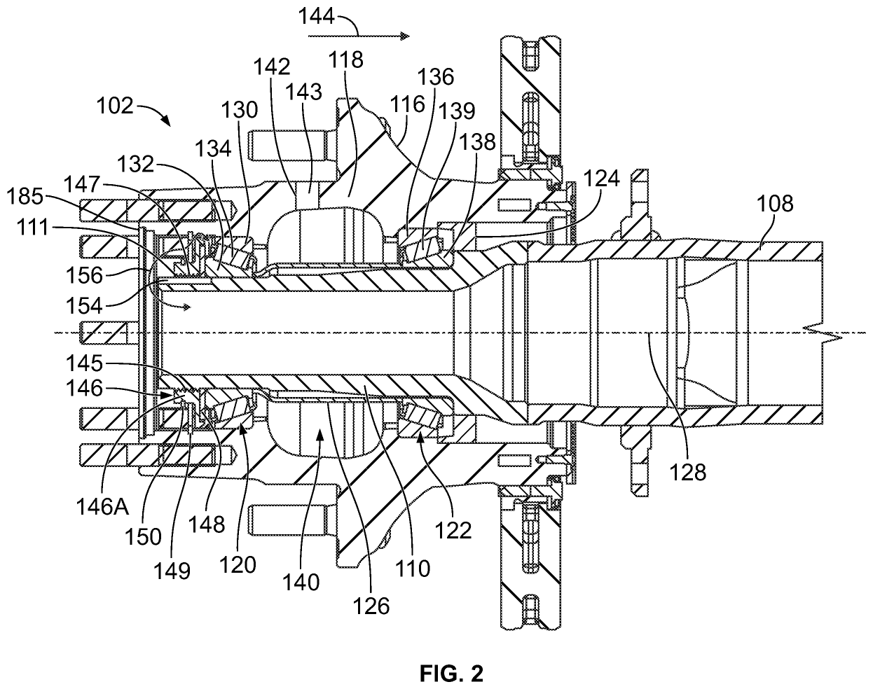

With respect to FIG. 2, one of the wheel hub assemblies 102 is shown mounted to the spindle 110 of the drive axle 100. The wheel hub assembly 102 shown in FIG. 2 permits lubricant to flow between the wheel hub assembly 102 and the drive axle 100 along flow path 156. The wheel hub assembly 102 includes a wheel hub 116 having a hub body 118, an outboard bearing assembly 120, an inboard bearing assembly 122, an inboard seal 124, and a spacer 126. The hub body 118 may have a unitary, one-piece construction and may be made of a metallic material such as steel, iron, or aluminum as some examples. The wheel hub assembly 102 is assembled onto the spindle 110. The outboard and inboard bearing assemblies 120, 122 permit the hub body 118 to rotate on the spindle 110 around central axis 128.

The outboard bearing assembly 120 includes an outer race, such as the outboard bearing cup 130, and inner race, such as the outboard bearing cone 132, and bearings, such as roller bearings 134. The inboard bearing assembly 122 includes an outer race, such as the inboard bearing cup 136, and inner race, such as the inboard bearing cone 138, and bearings, such as roller bearings 139. The hub body 118 forms a lubricant compartment 140 for containing lubricant for the bearing assemblies 120, 122. The hub body 118 may include a port 142 through which the lubricant compartment 140 may be filled with lubricant. The term filled with lubricant as used herein is intended to encompass a volume that permits normal operation of the components to be lubricated, such as partially filled. The port 142 may include a removable plug 143 for sealing the port 142 and permitting access to the lubricant compartment 140, for example, to add lubricant to the wheel hub assembly 102.

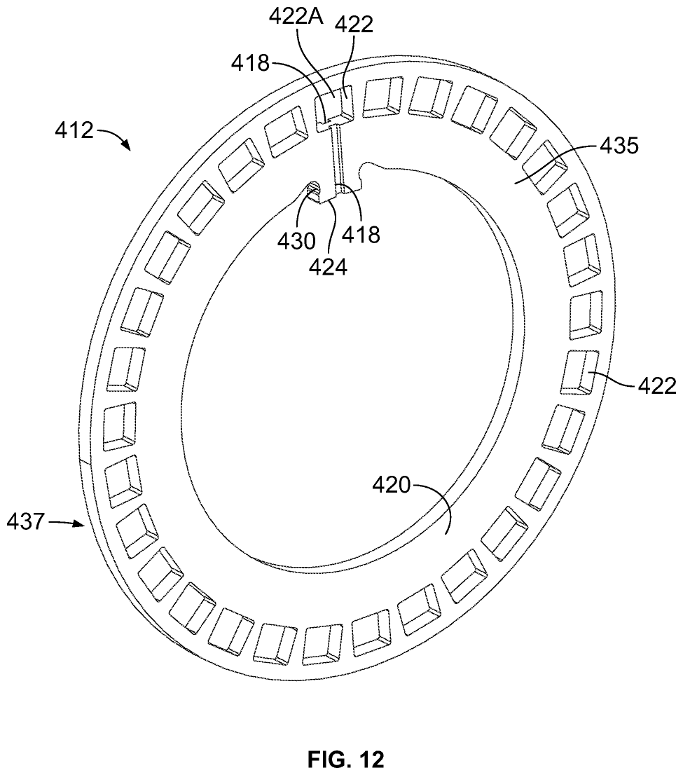

The wheel hub assembly 102 is mounted on the spindle 110 by advancing the wheel hub 116 in direction 144 along the spindle 110. The wheel hub assembly 102 includes a spindle nut 146 for securing the wheel hub assembly 102 on the spindle 110. The spindle nut 146 may have a unitary, one-piece construction or may be an assembly of components. In FIG. 3, the spindle nut 146 has a unitary, one-piece configuration and includes a nut body 145 having female threads 147 to engage male threads 111 of the spindle 110. The nut body 145 has a drive head portion 151 that is used to rotate the nut body 145 to secure the wheel hub 116 to the vehicle. The drive head portion 151 may have, in one embodiment, a hexagonal cross-section enabling a wrench or socket to be used to turn the nut body 145. The wheel hub assembly 102 may be advanced along the spindle 110 by threading the nut body 145 onto the spindle 110. The wheel hub assembly 102 may further include a lock washer 148, a spiral locking ring 149, and a lock ring 150 (see e.g., FIG. 3) for securing the nut body 145 to the spindle 110 and preventing the nut body 145 from rotating relative to the spindle 110 (e.g., unintentionally loosening or unthreading). The lock washer 148 includes a tab 152 (see FIG. 3) that extends into a keyway 154 of the spindle 110 such that the lock washer 148 is rotationally stationary relative to the spindle 110 during rotation of the hub body 118 and wheel mounted thereto. The lock ring 150 includes a tab that extends through an opening of the nut body 145 and an opening the lock washer 148. Because the lock washer 148 is fixed against rotary movement via the engagement of the tab 152 of the lock washer 148 in the keyway 154, the lock washer 148 inhibits rotary movement of the lock ring 150 by way of the tab of the lock ring 150 extending in the opening of the lock washer 148. Further, because the tab of the lock ring 150 extends in the opening of the nut body 145, the tab of the lock ring 150 inhibits turning of the nut body 145 about the spindle 110 while the tab of the lock ring 150 is engaged in the openings of the nut body 145 and the lock ring 148. An example lock ring 412 is discussed below with respect to FIG. 12.

FIGS. 3-7 illustrate the wheel hub assembly 102 with different seal systems that inhibit lubricant from flowing between the wheel hub assembly 102 and the drive axle 100. These seal systems retain the lubricant within the wheel hub assembly 102 which reduces reliance of the wheel hub assembly 102 on lubricant from the drive axle 100. The seal systems also limit the volume of fluid exchanged between the drive axle 100 and the wheel hub assembly 102 which limits mixing of the lubricant of the drive axle 100 and the lubricant of the wheel hub assembly 102. Isolation of the lubricant of the wheel hub assembly 102 allows the lubricant of wheel hub assembly 102 to be different than the lubricant of the drive axle 100. For example, the lubricant of the wheel hub assembly 102 may be a grease whereas the lubricant of the drive axle 100 may be an oil. While the sealing systems are described as being used with wheel hub assemblies 102 of drive axle 100, the sealing systems may similarly be used with non-driven wheel hub assemblies to retain lubricant within the wheel hub assembly. Additionally, while the following discussion describes various embodiments by way of example, it should be appreciated that the features and elements of one embodiment may be modified and/or combined with features and elements of one or more of the other embodiments.

With respect to FIG. 3, the wheel hub assembly 102 includes a seal system 160 that inhibits lubricant from flowing out of the wheel hub assembly 102 and into the drive axle 100. The seal system 160 includes a seal 161 and a portion of the spindle nut 146. The seal 161 is mounted to the wheel hub body 116 and extends radially inward to the spindle nut 146 and prevents lubricant, e.g., oil, from flowing through the seal 161. The seal 161 includes a seal body 162 and a sealing portion such as a sealing element. In one embodiment, the sealing element of the seal 161 is a lip seal 164.

The portion of the spindle nut 146 engaged by the seal 161 may include an outboard portion, such as an extension 168, of the nut body 145 of the spindle nut 146. The extension 168 has a cylindrical running surface 166 engaged by the lip seal 164 of the seal 161 to form a lubricant-tight seal between the seal 161 and the spindle nut 146. In one embodiment, the running surface 166 is cylindrical and the lip seal 164 is annular. When the lip seal 164 is in an undeflected state prior to being positioned around the spindle nut 146, the lip seal 164 has an inner diameter that is slightly smaller than an outer diameter of the running surface 166 such that the lip seal 164 resiliently engages the running surface 166 when the lip seal 164 is positioned around the spindle nut 146. The lip seal 164 is resiliently deformed a small distance radially outward due to the presence of the running surface 166 such that a radially inner portion of the lip seal 164 is resiliently biased into engagement with the running surface 166. During rotation of the wheel hub body 118, the lip seal 164 rotates around the running surface 166 and forms a dynamic seal between the lip seal 164 and the nut body 145. In one embodiment, the extension 168 does not extend axially beyond the outboard end of the spindle 110 when the spindle nut 146 is tightened down and secures the wheel hub assembly 102 to the spindle 110.

The seal body 162 is annular and sized to be inserted into a bore 119 of the body 118 of the wheel hub 116. The seal body 162 includes a structural member 170 and a sealing layer 172. The sealing layer 172 may be, for example, bonded to the structural member 170. In one embodiment, the sealing layer 172 includes the lip seal 164. The structural member 170 may be formed of a rigid material such as a metallic material such as steel, a plastic material, and/or a composite material such as fiber-reinforced plastic. The sealing layer 172 may be formed of a polymer material such as a rubber material such as nitrile rubber. The sealing layer 172 may include pockets 174, 176 such that the sealing layer 172 extends around the radially inner and radially outer ends of the structural member 170 which provides a sealing surface about the ends of the structural member 170 (e.g., on both sides of the structural member 170) and which may aid to secure the sealing layer 172 to the structural member 170.

The seal 161 includes a mounting end portion 182 for mounting the seal 161 to the wheel hub 116. The mounting end portion 182 may be pressed into a groove 184 formed on a radially inner surface of the wheel hub 116 to attach the seal 161 to the wheel hub 116. The sealing layer 172 of the mounting end portion 182 has an outer diameter slightly larger than the inner diameter of the groove 184. The interference between the sealing layer 172 and the groove 184 retains the seal 161 in the groove 184 while a user is positions the semi-shaft 106 into the spindle 110 and secures a flange 186 of the semi-shaft 106 to the studs 117 using nuts.

The mounting end portion 182 of the sealing layer 172 is sandwiched between a flange 186 of the semi-shaft 106 and an outboard end 185 of the wheel hub 116 to form a lubricant tight seal. The mounting end portion 182 also fixes the seal body 162 to the wheel hub 116 to inhibit the seal body 162 from rotating relative to the wheel hub 116. The seal body 162 may mount to the wheel hub 116 by an interference fit connection. For example, the outer diameter of the seal body 162 may be slightly larger than an inner diameter of the groove 184 of the wheel hub 116. The seal body 162 may be pressed into the groove 184 of the wheel hub 116 to attach the seal body 162 to the wheel hub 116 and held in place by the frictional engagement between the seal body 162 and the wheel hub 116.

The seal body 162 includes one or more wall portions extending from the inner surface of the wheel hub 116 toward the running surface 166 to support the lip seal 164 at the running surface 166. In FIG. 3, the wall portions of the seal body 162 include a first radial portion 188 extending radially inward to an axial portion 190. The axial portion 190 extends inboard to a second radial portion 192. The second radial portion 192 is configured to position the lip seal 164 in engagement with the running surface 166 when the seal 161 is mounted in the wheel hub 116 after the wheel hub 116 and spindle nut 146 have been connected to the spindle 110.

The lip seal 164 extends from the seal body 162 to contact the running surface 166. The lip seal 164 may be formed of a rubber material (e.g., nitrile rubber). The lip seal 164 is biased into contact with the running surface 166 of the extension 168. For instance, the lip seal 164 may be elastically deflectable such that when the lip seal 164 engages the running surface 166 the lip seal 164 is deflected slightly radially outward such that the lip seal 164 applies a resilient reaction force radially inward and against the running surface 166. The lip seal 164 rotates with the seal body 162 and the wheel hub 116 when the vehicle is motion. The lip seal 164 remains in contact with the running surface 166 as the lip seal 164 rotates about the nut body 145 thus forming a dynamic seal. The lip seal 164 inhibits lubricant contained within the wheel hub 116 from flowing out of the wheel hub assembly 102 to the drive axle 100. The tip of the seal 164 in contact with the running surface 166 may be shaped to create a pressure differential between the inboard side and outboard side of the seal 164. As used herein, the term outboard refers to a direction away from the vehicle and inboard refers to a direction toward the vehicle. For instance, the tip of the lip seal 164 may have an inboard surface and an outboard surface that each extend away from the running surface 166 at an angle. The inboard surface may extend at a steeper angle relative to the running surface 166 than the outboard surface such that lubricant that attempts to travel outboard between the lip seal 164 and running surface 166 is pumped inboard by the lip seal 164 due to the rotation of the wheel hub 116. For example, the inboard surface may approach the running surface 166 at a 40-70 degree angle and the outboard surface may approach the running surface 166 at a 20-35 degree angle.

To install the seal system 160, wheel hub 116 is mounted on the spindle 110 and secured to the spindle 110 via the spindle nut 146, lock ring 150, spiral locking ring 149, and lock washer 150. The seal 161 is advanced into the bore 119 and the mounting end portion 182 is seated in a groove 184 of the bore 119. When the mounting end portion 182 is seated in the groove 184, the lip seal 164 is positioned to engage the running surface 166 of the spindle nut 146 and form a dynamic seal with the spindle nut 146. The half shaft 106 is then assembled into the spindle 110 and secured to studs 117 of the wheel hub 116 via nuts. Tightening of the nuts on the studs 117 clamps the mounting end portion 182 of the seal 161 between the flange 186 of the half shaft 106 and a radial surface 187 of the groove 184. The engagement of the sealing layer 172 of the mounting end portion 182 with the flange 186 and the wheel hub 116 forms a static seal between the seal 161, flange 186, and wheel hub 116.

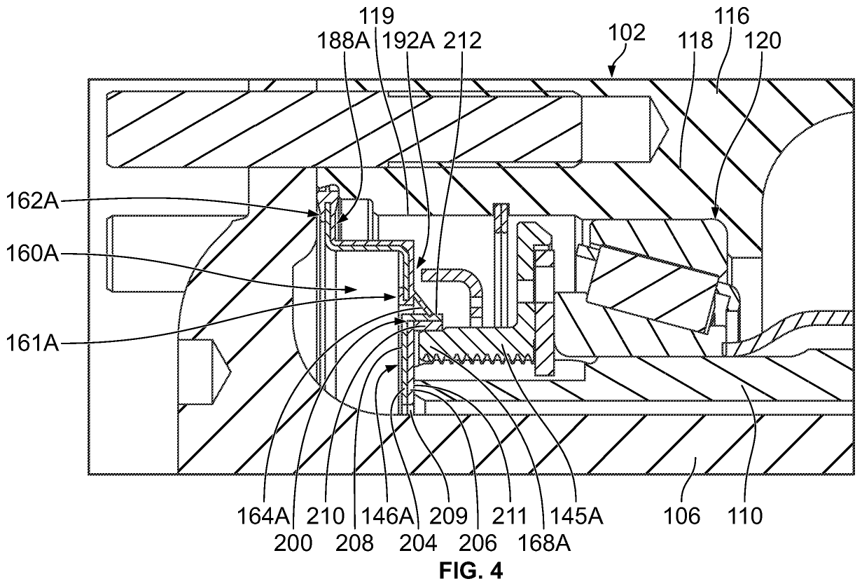

With respect to FIG. 4, a seal system 160A is provided that may be utilized in the wheel hub assembly 102 instead of the seal system 160. The seal system 160A includes a spindle nut 146A with a two-piece configuration including a nut body 145A and a sleeve 200. The sleeve 200 is configured to be mounted over the extension 168A of the nut body 145A. The sleeve 200 includes a structural member 204 and a sealing layer 206 bonded to the inboard side of the structural member 204. The structural member 204 may be formed of a rigid material such as a metallic material, a plastic material, and/or a composite material. The sealing layer 206 may be formed of a polymer material such as rubber material such as nitrile rubber.

The sleeve 200 includes a radial portion 208 and an axial portion 210. The radial portion 208 defines a central opening 209 through which the semi-shaft 106 extends when the sleeve 200 is mounted to the nut body 145A. The radial portion 208 extends from the central opening 209 radially outward to the axial portion 210. The axial portion 210 is cylindrical and is sized to be pressed onto the extension 168 of the nut body 145A. The inner diameter of the sealing layer 206 of the axial portion 210 of the sleeve 200 may be the same size or smaller than the outer diameter of the extension 168 of the nut body 145A such that the sleeve 200 is held in place on the nut body 145A by a friction fit. The friction fit between the sleeve 200 and the nut body 145A keeps the sleeve 200 from rotating relative to the nut body 145.

The sealing layer 206 forms a static seal with the extension 168 of the nut body 145A to prevent lubricant from flowing between the sleeve 200 and the nut body 145A. The sleeve 200 may be pressed onto the nut body 145A until the sealing layer 206 of the radial portion 208 contacts an axial end surface 211 of the spindle 110. The sealing layer 206 of the radial portion 208 may be pressed against the axial end surface 211 of the spindle 110 to form a static fluid tight seal therebetween and further resist rotation of the sleeve 200 relative to the spindle 110 and the nut body 145A. By overlapping and abutting the axial end surface 211 of the spindle 110 in an axial direction, the sleeve 200 may inhibit fluid from exiting the wheel hub assembly 102 via the keyway 154 once the spindle nut 146A has been secured to the spindle 110. The radial portion 208 of the sleeve 200 has an continuous, annular configuration such that the sealing layer 206 of the radial portion 208 axially overlaps and abut the keyway 154 to inhibit lubricant leakage via the keyway 154 at any rotational position of the sleeve 200 on the spindle 110.

The outer surface of the axial portion 210 of the sleeve 200 is cylindrical and provides an annular, smooth running surface 212 which the lip seal 164 contacts and rotates about. In the embodiment of FIG. 4, the lip seal 164A of the seal 161A engages the running surface 212 of the sleeve 200 instead of the extension 168 of the nut body 145A as in the embodiment shown in FIG. 3. The lip seal 164A creates a dynamic seal with the sleeve 200 inhibiting lubricant from flowing out of the wheel hub assembly 102 similar to the embodiment of FIG. 3 described above. The sleeve 200 of FIG. 4 may have a larger outer diameter compared to the extension 168 of the nut body 145 of FIG. 3. The seal 161A is configured to support the lip seal 164A at a position to engage the sleeve 200. In particular, the length of the first radial portion 188A and/or second radial portion 192A of the seal 161A may be shortened to reduce the radial extent of the seal 161A to accommodate the larger outer diameter of the sleeve 200.

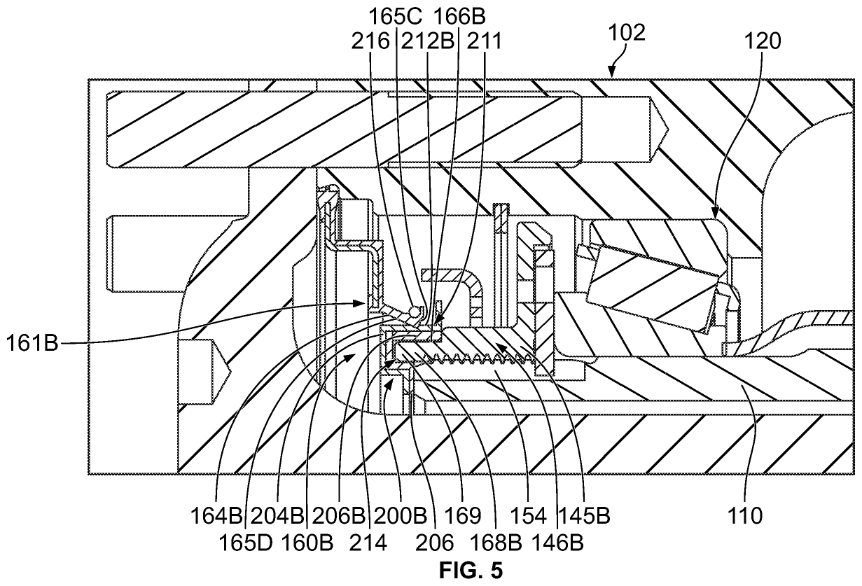

With respect to FIG. 5, another seal assembly 160B is provided that may be used with the wheel hub assembly 102. The seal assembly 160B includes a seal 161B and a spindle nut 146B. The spindle nut 146B includes a nut body 145B and a sleeve 200B. The nut body 145B has an extension 168B with an axial length greater than the extension 168 in FIG. 3. The extension 168B has a portion 169 extending axially beyond the axial end surface 211 (see FIG. 4) of the spindle 110. In this embodiment, the sleeve 200B includes a pocket 214 on an inboard surface of the sleeve 200B that is sized to receive the portion 169 of the extension 168B of the nut body 145B extending axially beyond the axial end surface 211 of the spindle 110. The sleeve 200B has the sealing layer 206B configured to form a seal with the axial end surface 211 of the spindle 110. The sealing layer 206B resembles a U-shaped channel that receives the portion 169 of the nut body 145B such that the sealing layer 206 contacts a radially inner surface portion of the portion 169, a radially outer surface portion of the portion 169, and an axial end surface of the portion 169 as shown in FIG. 5.

To attach the sleeve 200B to the nut body 145B, the pocket 214 of the sleeve 200 may be concentrically aligned with the extension 168 of the nut body 145B. The sleeve 200B is pressed onto the nut body 145B to attach the sleeve 200B to the nut body 145B. The pocket 214 increases the surface area of the sealing layer 206 that can engage with the nut body 145B and spindle 110 to increase the frictional engagement therebetween. The sleeve 200B is pressed onto the nut body 145B until the pocket 214 is seated on the portion 169 of the nut body 145B and the sleeve 200B contacts the axial end surface 211 of the spindle 110. The sealing layer 206B axially overlaps the keyway 154 and prevents lubricant from flowing out of the wheel hub assembly 102 via the keyway 154.

The sleeve 200 of the embodiment of FIG. 5 includes an axial portion 210B having an axial length that is larger than the axial length of the axial portion 210 of the sleeve 200 of the embodiment of FIG. 4. This increases the area of the running surface 212B of the sleeve 200B which accommodates a greater degree of variation in the manufacturing of the seal 161B and the position of the lip seal 164B. The seal 161B may include a resilient member, such as a garter spring 216, attached to the lip seal 164B to bias the lip seal 164B into engagement with the running surface 212B of the sleeve 200B. The garter spring 216 may be formed of a metallic material, such as steel. The portion of the lip seal 164B in contact with the running surface 212B may be shaped to create a pressure differential between the inboard side and outboard side of the lip seal 164B. The lip seal 164B includes an inboard surface 165C and an outboard surface 165D that extend away from the running surface 212B at an angle. The inboard surface 165C extends at a steeper angle relative to the running surface 212B than the outboard surface 165D such that lubricant that attempts to travel outboard between the lip seal 164B and running surface 212B is pumped inboard by the lip seal 164B due to the rotation of the wheel hub 116. For example, the inboard surface 165C may approach the running surface 212B at a 40-70 degree angle and the outboard surface 165D may approach the running surface 212B at a 20-35 degree angle.

While the garter spring 216 is provided with respect to the embodiment of FIG. 5, a spring may similarly be used with the other embodiments described herein to bias the lip seals into engagement with the sleeve (e.g., sleeve 200) or extension (e.g., extension 168) of the associated spindle nut. The garter spring 216 may aid in forming a tighter seal between the lip seal 164B and the running surface 212B. The garter spring 216 may keep the lip seal 164B in engagement with the running surface 212B over the lifespan of the seal system 160B. In other forms, the garter spring 216 is not used which may reduce the frictional resistance between the lip seal 164B and the running surface 212B.

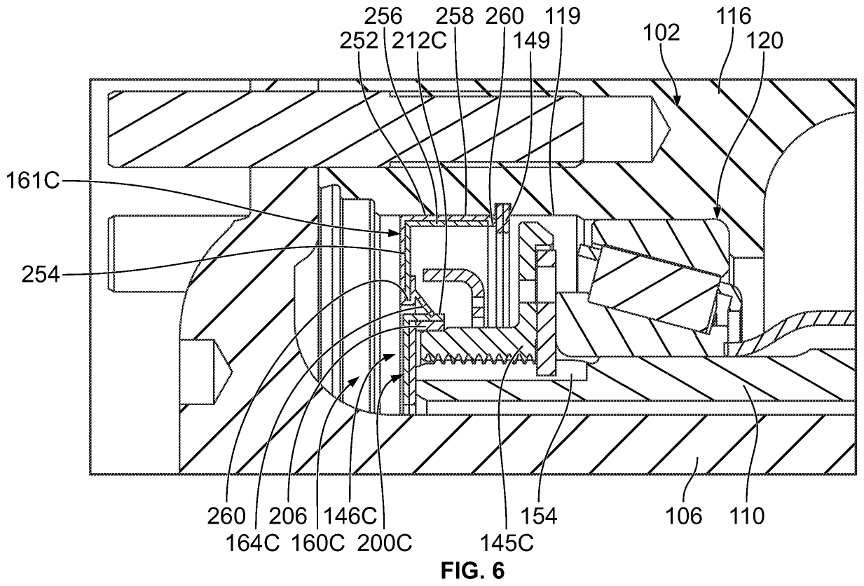

With respect to FIG. 6, a seal system 160C is provided for use with the wheel hub assembly 110. The seal system 160C includes a seal 161C and a spindle nut 146C. The spindle nut 146C includes a nut body 145C and a sleeve 200C. The seal system 160C is similar to the seal systems 160, 160A, 160B discussed above such that differences will be highlighted. For example, the seal system 160C includes a seal 161D having an axial portion 252 and a radial portion 254 extending radially inward from the axial portion 252. The seal 161D includes a structural member 256 and a sealing layer 258 attached to the structural member 256. The structural member 256 may be formed of a rigid material such as a plastic, a composite, or a metallic material including steel, iron, or aluminum as some examples. The sealing layer 258 may include pockets 260 for receiving the ends of the structural member 256 to secure the sealing layer 258 to the structural member 256. The sealing layer 258 may be secured to the structural member 256 by chemical bonding, such as overmolding the sealing layer 258 on the structural member 256, or an adhesive as some examples.

The outer diameter of the sealing layer 258 may be slightly larger than the internal diameter of the bore 119 of the wheel hub 116 such that the seal 161C may be pressed into the bore 119 of the wheel hub 116 and secured therein by an interference fit. The interference fit between the seal 161C and the inner diameter of the internal bore 119 maintains the axial position of the seal 161C along the internal bore 119 rather than being clamped between portions of the semi shaft flange 182 (see, e.g., FIG. 3) and the hub body 118. The seal 161D may be pressed into the bore 119 until the end of the seal 161D seats against the spiral locking ring 149 of the wheel hub assembly 102. The axial portion 252 may be sized such that once the seal 161C seats against the spiral locking ring 149, the lip seal 164C of the seal 161D is properly positioned along the axis of rotation, e.g., the lip seal 164C engages a running surface 212C of a sleeve 200C near the middle of the running surface 212C to create a dynamic seal.

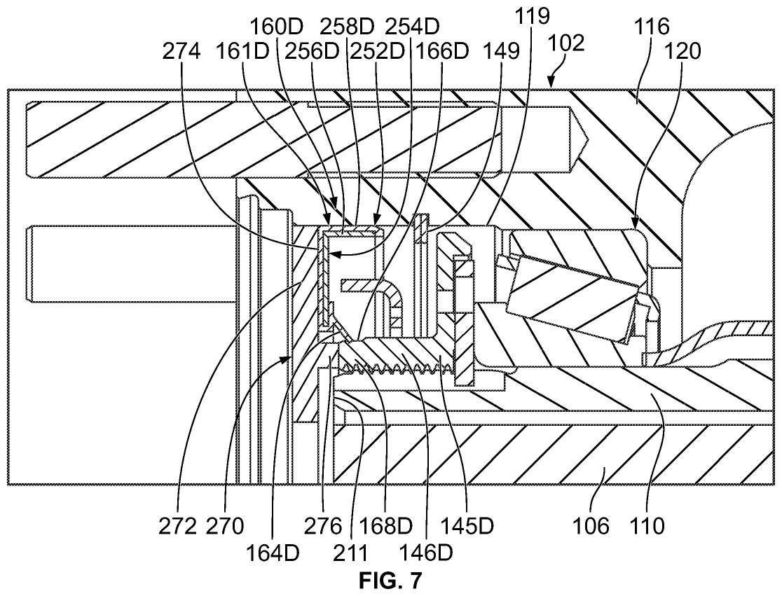

With respect to FIG. 7, a seal system 160D is provided that may be used with the wheel hub assembly 102. The seal system 160D includes a seal 161D and a spindle nut 146D with a nut body 145B. The seal system 160 of FIG. 7 is similar in many respects to that of FIG. 6 such that differences will be highlighted. For example, the seal system 160D of FIG. 7 has a different configuration of the seal 161D and the spindle nut 146D does not include a sleeve. The spindle nut 146D has a radial portion 254D sized to extend radially inward to support a lip seal 164D at a position to engage a running surface 166D of an extension 168D of the spindle nut 146D. The seal 161D has an axial portion 252D of a reduced axial length compared to the seal 161C of FIG. 6 such that the seal 161D does not seat against the ring 149 of the wheel hub assembly 102.

An insertion tool 270 is used to insert the seal 161D into the bore 119 of the wheel hub 116 to the proper position rather than inserting the sealing body 250 until the sealing body contacts the ring 149. The insertion tool 270 is used to insert the sealing body 250 after the wheel hub 116 has been positioned on the spindle 110 and the spindle nut 146 has been fixed to the spindle 110. Once the sealing body 250 has been installed using the insertion tool 270, the insertion tool 270 is removed and the semi-shaft 106 is connected to the wheel hub 116.

The insertion tool 270 is configured to position the seal 161D at a predetermined axial position along the radially inner surface of the bore 119 so that the lip seal 164D engages the running surface 166D of the extension 168D of the nut body 145D of the spindle nut 146D. The insertion tool 270 includes an annular plate portion 272 sized to be inserted into the bore 119 of the wheel hub 116. The plate portion 272 may be circular or ring shaped. The plate portion 272 includes an engagement surface 274 that is pressed against the radial portion 254D of the seal 161D to shift the seal 161D axially into the bore 119 of the wheel hub 116. The insertion tool 270 includes a protrusion 276 extending axially from the engagement surface 274 that is sized to engage the outboard end surface of the extension 168D of the spindle nut 146D and/or the axial end surface 211 of the spindle 110. The protrusion 276 engages the spindle nut 146D and/or spindle 110 to form a stop that limits inboard movement of the insertion tool 270 and the seal 161D supported thereon. The axial length of the protrusion 276 may be set such that when the protrusion 276 abuts the spindle nut 146D and/or spindle 110, the seal 161D is located at the desired position with the lip seal 164D engaging the running surface 166D of the extension 168D of the spindle nut 146D. In some forms, the seal system 160D of the embodiment of FIG. 7 may include a sleeve attached to the extension 168D of the spindle nut 146D as in other embodiments.

While the above embodiments describe the seals 161, 161A, 161B, 161C, 161D forming a static seal with the body 118 of the wheel hub 116 and a dynamic seal with the running surfaces 166, 166A of the spindle nut 146 or running surface 212 of the sleeve 200, in other forms the seal assembly 160 may form a static seal with the spindle nut 146 and/or sleeve 200 and a dynamic seal with the wheel hub 116. For example, the seal body 162 may define a central opening sized to be pressed on to the spindle nut 146 or sleeve 200 to form a static fluid tight seal and secure the seal body 162 thereto by an interference fit. In another approach, the seal body 162 may have a central opening that receives the spindle 110 and the spindle nut 146 clamps the seal body 162 axially against a shoulder of the spindle 110 to secure the seal body 162 to the spindle 110.

In embodiments wherein the seal body 162 is mounted to the spindle 110, the seal body 162 may be substantially stationary relative to the spindle nut 146 and spindle 110 when the vehicle is in motion. The lip seal 164 may extend radially outward from the seal body 162 to a radially inner, running surface of the bore 119 of the wheel hub 116 to form a dynamic fluid tight seal. The wheel hub 116 rotates about the seal body 162 with the lip seal 164 remaining in contact with the wheel hub 116 to inhibit lubricant from flowing out of the wheel hub 116.

In some forms, a sleeve 200 may be pressed on to the extension 168 of the spindle nut 146. An inner diameter of the sleeve 200 may be radially aligned with the extension 168 of the spindle nut 146 with the sleeve 200 pressed onto the extension 168 of the spindle nut 146. Pressing the sleeve 200 onto the extension 168 of the spindle nut 146 forms a static seal between the sleeve 200 and the extension 168 and secures the sleeve 200 to the extension 168 by an interference fit. For embodiments wherein a sleeve 200 is used, the seal body 162, 250 may be pressed axially into the wheel hub 116 to bring the lip seal 164 into contact with the running surface 212 of the sleeve 200.

In some forms, the insertion tool 270 may be used to insert the seal body 250 into the wheel hub 116. The seal body 250 may be aligned with the bore 119 of the wheel hub 116 and the engagement surface 274 of the plate 272 of the insertion tool 270 pressed against the seal body 250 to shift the seal body 250 axially into the bore 119. The insertion tool 270 may be urged against the seal body 250 until the protrusion 276 of the insertion tool 270 seats against the spindle 110 or spindle nut 146 to keep the insertion tool 270 from moving farther inboard in the axial direction. The protrusion 276 has a length such that the seal body 250 is in the desired position, e.g., with the lip seal 164 at the running surface of the sleeve 200 or spindle nut 146, when the protrusion 276 seats against the spindle 110 or spindle nut 146.

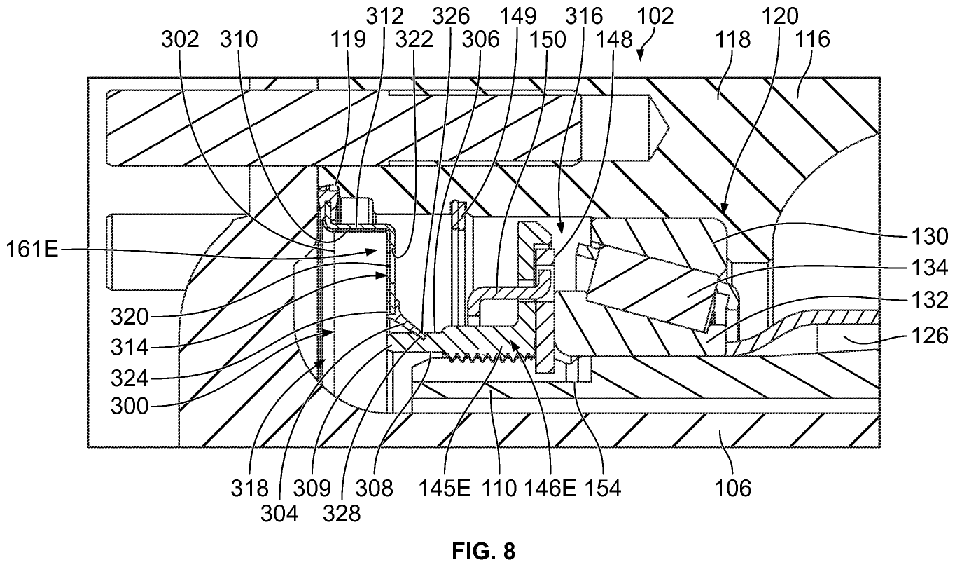

With respect to FIG. 8, the wheel hub assembly 102 is shown having a seal system 300 according to another embodiment. The seal system 300 is similar in many respects to the embodiments of the seal systems described above such that the differences will be highlighted. The seal system 300 includes a seal 161E and a spindle nut 146E with a nut body 145E. The seal 161E has a lip sealing member 304 that engages a cylindrical running surface 306 of an outboard portion, such as extension 308, of the nut body 145E. In this embodiment, the axial length of the extension 308 of the nut body 145E is increased. As shown, the extension 308 may have a portion 309 extending axially beyond the outboard end of the spindle 110. The increased axial length of the running surface 306 may provide for a greater surface area for the sealing member 304 to engage to form a fluid tight seal. For example, the increased axial length allows for a greater degree of variation in the position of the sealing member 304.

The seal 161E has a seal body 302 with a structural member 312 and a sealing layer 310. The sealing layer 310 is attached (e.g., bonded) to the outboard side of the structural member 312. The seal body 302 may include a valve portion such as one or more vents 314 that permit air to pass therethrough. The vents 314 may aid to control the pressure within a lubrication cavity 316 of the wheel hub 116. For example, when the pressure in the lubrication cavity 316 exceeds a threshold, air in the lubrication cavity 316 may be forced through the vents 314 to a drive shaft cavity 318. By permitting air pressure to release through the vents 314, the air pressure in the area inboard of the seal 161E may be kept below a predetermined maximum pressure or pressure range. Excess air pressure in a wheel hub has been found to reduce the durability of internal components of the wheel hub such as the outboard bearing assembly 120 and the inboard bearing assembly 122 of the wheel hub 116. In another embodiment, the vents 314 are include a material that is air-permeable and lubricant-impermeable.

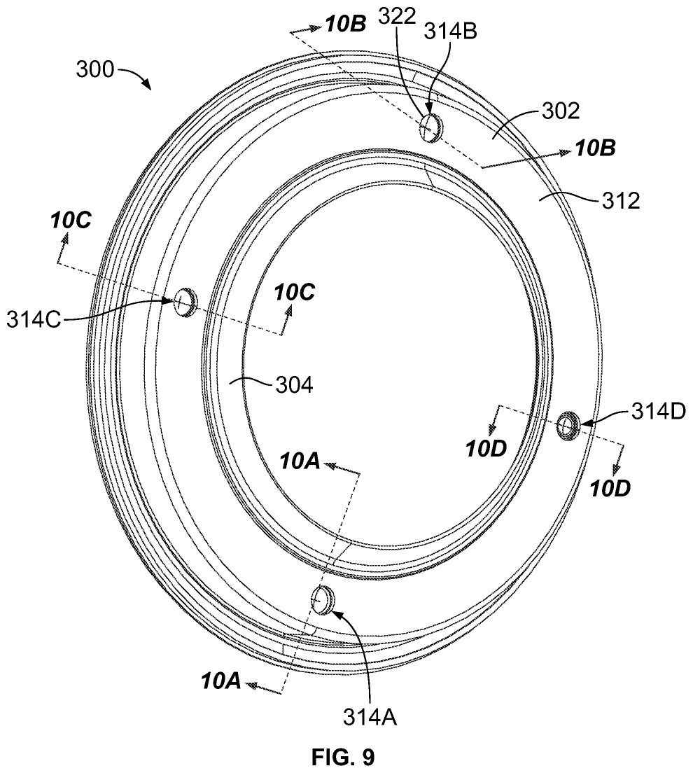

With respect to FIG. 9, the seal body 302 may include a plurality of vents 314 positioned about the annular seal body 302. Including multiple vents 314 about the seal body 302 ensures that at least one of the vents 314 will be above the level of the lubricant in the lubrication cavity 316, for example, when the wheel hub 116 is at rest and not rotating, to permit air above the surface of the lubricant to pass out of the lubrication cavity 316 through the vent 314. While four vents 314 are shown by way of example, the seal body 302 may include any number of vents 314.

Each vent 314 may be formed by an opening 322 in the structural member 312 that is axially aligned with one or more slits 320 in the sealing layer 310. For example, the vents 314 may be formed by cutting a slit 320 in the sealing layer 310 at the opening 322 in the structural member 312, e.g., after the sealing layer 310 is bonded to the structural member 312.

The lip sealing member 304 is mounted to the structural member 312. The lip sealing member 304 includes an attachment portion 324 that is mounted to the radially inner end of the structural member 312. The lip sealing member 304 may be formed of a polymer such as a rubber material such as nitrile rubber. The lip sealing member 304 is a resilient, annular member and is deformed or expanded slightly radially outward by the presence of the extension 308 in the central opening of the lip sealing member 304. Because the material of the lip sealing member 304 is resilient, the lip sealing member 304 biases a contact portion 326 of the lip sealing member 304 radially inward into engagement with the running surface 306.

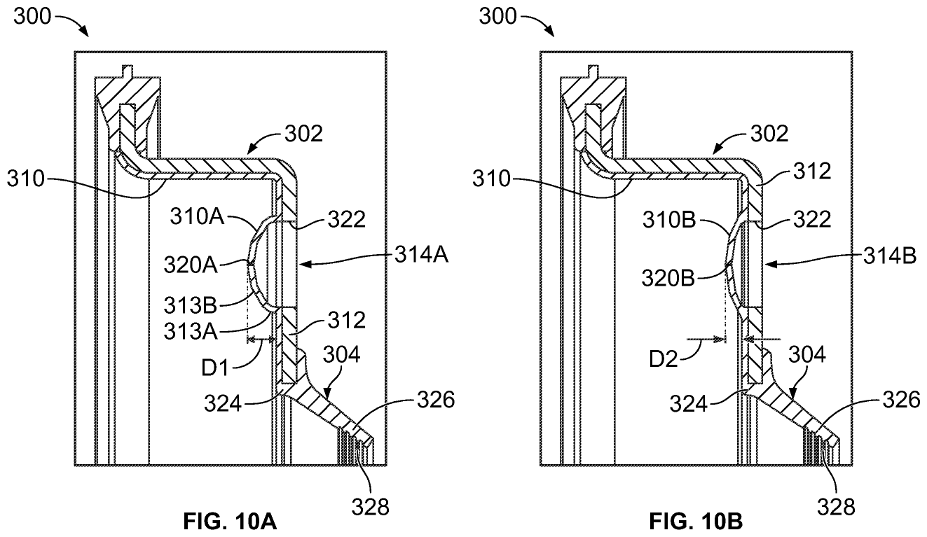

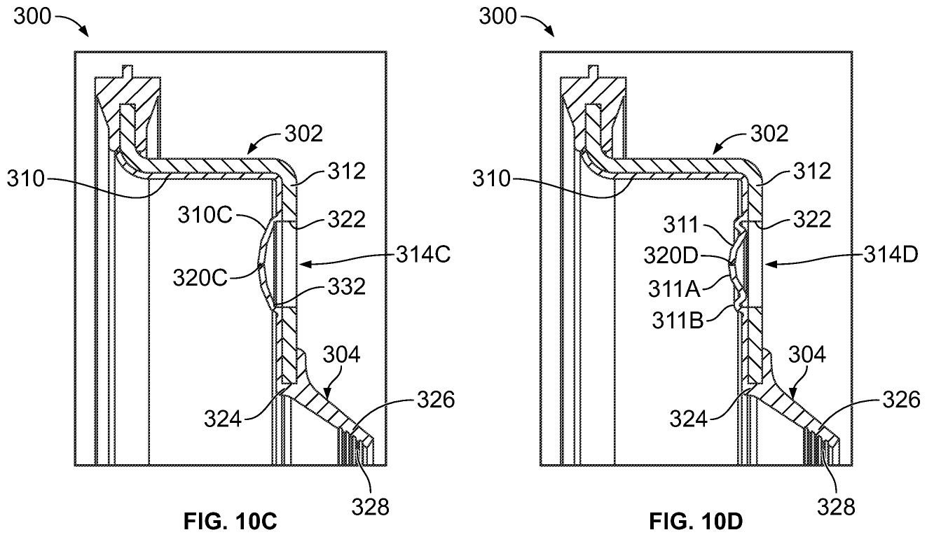

When installed, the lip sealing member 304 may be curved to position a radially inner surface of the contact portion 326 of the lip sealing member 304 in concentric, sliding contact with the running surface 306. The radially inner surface of the contact portion 326 may include one or more ridges 328 (see FIG. 10A) shaped to create a pressure differential between an outboard side and an inboard side of the lip sealing member 304. For instance, the ridges 328 of the lip sealing member 304 may each have an inboard surface portion and an outboard surface portion that each extend away from the running surface 306 at an angle. The inboard surface portion of each ridge may extend at a steeper angle relative to the running surface 306 than the outboard surface portion of the ridge such that lubricant that attempts to travel in the outboard direction between the lip sealing member 304 and the running surface 306 is pumped inboard by the lip sealing member 304 due to the rotation of the lip sealing member 304 around the running surface 306. For example, the inboard surface portion of each ridge 328 may approach the running surface 306 at an angle of 40-70 degrees and the outboard surface of the contact portion 326 may approach the running surface 306 at an angle of 20-35 degrees.

With reference to FIGS. 10A-10D, examples of the vents 314 are shown. Regarding FIG. 10A, the sealing layer 310 has a dome-shaped portion 310A of a vent 314A that bulges in the outboard direction a first distance D1. The dome-shaped portion 310A of the sealing layer 310 may include a cylindrical portion 313A extending from the structural member 312 and a convex portion 313B. The slit 320A is formed in the apex of the convex portion 313B. Forming the sealing layer 310 into a dome-shape may keep the slit 320A closed once formed. For example, the sealing layer 310 molded to the structural member 312 may tend to shrink as the sealing layer 310 cools after being molded to the structural member 312. The shrinking of the sealing layer 310 produces internal tension in the material of the sealing layer 310. The dome-shaped portion 310A may release the internal tension in the material of the sealing layer 310 that extends across the opening 322 of the structural member 312. The slit 320A may be formed in the dome-shaped portion 310A after the seal 161E has been removed from the mold, such as by using a cutter. Because there is reduced internal tension in the material of the sealing layer 310 in the dome-shaped portion 310A, the dome-shaped portion 310A may firmly reclose after forming of the slit 320A.

Regarding FIG. 10B, the vent 314 is shown according to another embodiment where the sealing layer 310 includes a dome-shaped portion 310B of the vent 314B that extends outboard a distance D2 which is less than distance D1 of the embodiment of FIG. 10A. The air pressure required to open the slit 320B of the vent 314B of this embodiment may be less than the air pressure required to open the slit 320B embodiment of FIG. 10A due to the reduced outboard dimension of the dome-shaped portion 310B. The resistance of the vent 314 may be adjusted by adjusting the outboard dimension of the dome-shaped portion of the sealing layer 310. The resistance of the vent 314 may be selected based on the application (e.g., based on the type of lubricant used).

Regarding FIG. 10C, a vent 314C is shown according to another embodiment where the dome portion 310C of the sealing layer 310 includes an annular groove 332 about the periphery of the opening 322 in the structural member 312. The annular recess 332 may aid to facilitate bending in the sealing layer 310 at the annular recess 332 which reduces the stiffness of the dome portion 310C and permits the slit 320C to open at a lower air pressure than the vent 314B.

Regarding FIG. 10D, a vent 314D is shown according to another embodiment where a portion 311 of the sealing layer 310 forming the vent 314 has a generally W-shaped cross-section. The portion 311 of the sealing layer 310 forming the vent 314 includes a dome portion 311A and a ring portion 311B extending about the dome 311A. The dome 311A and the ring 311B bulge in the outboard direction. The ring 311B about the dome 311A may further reduce the internal tension in the dome 311A after molding the sealing layer 310 onto the structural member 312.

With reference again to FIG. 9, in some forms, the vents 314 of the seal body 302 may all be the same. In other forms, the seal body 302 may include two or more different types of vents, such as those of the embodiments discussed above.

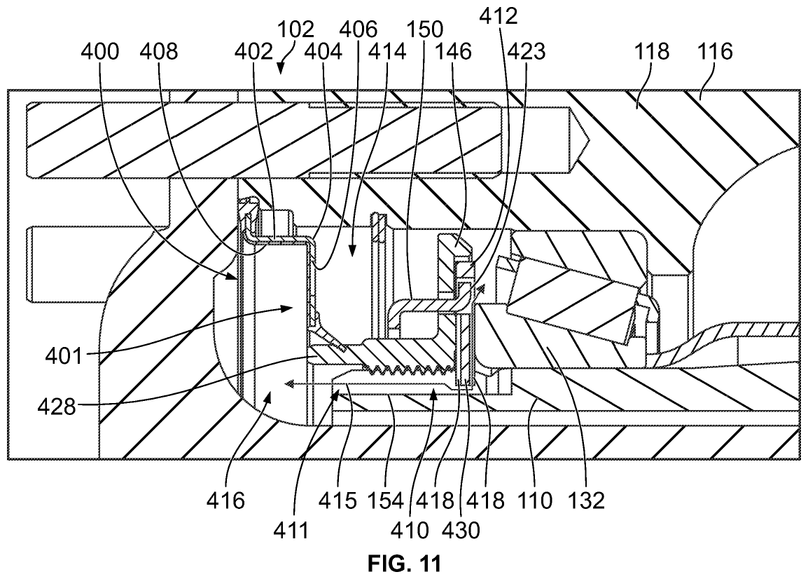

With respect to FIG. 11, the wheel hub assembly 102 is shown having a seal system 400 according to another embodiment. The seal system 400 is similar in many respects to the seal system 300 of FIG. 9 such that the differences will be highlighted. The seal system 400 includes a seal 401 without a vent and a spindle nut 428. The seal 401 has a structural member 404 and a sealing layer 408. The structural member 404 has openings 406, but the sealing layer 408 does not include a slit and thus air is unable to pass therethrough. In other forms, the seal body 402 does not include the openings 406 in the structural member 404.

The seal system 400 has a vent 410 such as a passageway 411 extending from the keyway 154 to the lubrication cavity 414. As one example, the vent 410 may be formed in part by one or more vents, such as recesses or slots 418 (see also FIG. 12), formed in the lock washer 412 that extend radially from the keyway 154 to the lubrication cavity 414. Air may flow along flow path 415 from the lubrication cavity 414, through one or both of the slots 418, and to the drive shaft cavity 416.

With reference to FIG. 12, the lock washer 412 has an annular body 420 with a plurality of locking openings 422 around a periphery of the annular body 420. The locking openings 422 are sized to receive one or more tabs 423 of the lock ring 150 (see FIG. 11) to secure the spindle nut 428 to the lock washer 412 and inhibit the spindle nut 428 from rotating once threaded onto the spindle 110.

The lock washer 412 includes a protrusion, such as a tab 430, that extends radially inward into the keyway 154 of the spindle 110. The engagement of the tab 430 in the keyway 154 prevents the lock washer 412 and the spindle nut 428 and lock ring 150 connected thereto from rotating about the spindle 110 until a user removes the tab 423 of the lock ring 150 from the associated locking opening 422. The slots 418 of the lock washer 412 extend radially along opposing faces or side surfaces 435, 437 of the lock washer 412. The slots 418 are open-ended slots and open to the locking opening 422A at one end of the slots 418 and to a terminal end 424 of the tab 430 at the other end of the slots 418. Because the terminal end 424 of the tab 430 is disposed in the keyway 154, air from the lubrication cavity 414 can travel through the locking opening 422A, along the slots 418, and into the keyway 154. In FIG. 12, the lock washer 412 is symmetrical about a plane between the side surfaces 435, 437 such that either surface 435, 437 may be positioned against the outboard bearing cone 132 and the slots 418 are open to permit air to travel therethrough. In another embodiment, the lock washer 412 may have a slot 418 formed on only one of the side surfaces 435, 437.

With reference again to FIG. 11, when the lock washer 412 is installed, the lock washer 412 is sandwiched between the spindle nut 428 and the outboard bearing cone 132. The opposing side surfaces 435, 437 (see FIG. 12) of the lock washer 412 are pressed against the spindle nut 428 and outboard bearing cone 132 such that the slots 418 define a portion of the passageway 411 between the keyway 154 of the spindle 110 and the lubrication cavity 414. The slots 418 may be sized to permit air to travel between the lubrication cavity 414 and the drive shaft cavity 434 but substantially restrict the flow of lubricant therethrough.

The keyway 154 of the spindle 110 is positioned at the top of the spindle 110 when looking at the end of the spindle 110 as shown in FIG. 11, e.g., at the twelve o'clock position. The keyway 154 may be positioned at other positions about the top of the spindle 110, such as in the eleven o'clock to one o'clock positions. With the keyway 154 and slots 418 at the top of the spindle 110, when the wheel hub 116 stops rotating, the fill level of the lubricant in the lubrication cavity 414 is below the keyway 154 and the slots 418 which limits lubricant from leaking through the vent 410 when the wheel hub 116 is stationary. Further, because the keyway 154 and slots 418 are at the top of the spindle 110, it is difficult for the lubricant to splash into the slots 418 and escape through the vent 410 during rotation of the wheel hub 116.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. An apparatus for retaining lubricant in a wheel hub assembly, the wheel hub assembly including a wheel hub and a spindle nut for securing the wheel hub to a vehicle spindle, the apparatus comprising:
an annular lubricant seal;
a mounting portion of the lubricant seal to be mounted to the wheel hub;
a central opening of the lubricant seal to receive a running surface of the spindle nut; and
a sealing portion of the lubricant seal extending around the central opening of the lubricant seal, the sealing portion configured to form a dynamic seal with the running surface of the spindle nut and keep the lubricant from escaping between the sealing portion of the lubricant seal and the running surface of the spindle nut as the wheel hub rotates around the vehicle spindle.

2. The apparatus of claim 1 wherein the lubricant seal includes a structural member and a sealing member;
wherein the mounting portion includes portions of the structural member and the sealing member configured to form a lubricant-tight seal with the wheel hub; and
wherein the sealing portion includes a protruding portion of the sealing member.

3. The apparatus of claim 1 wherein the lubricant seal is rotatable around a central axis;
wherein the lubricant seal includes a sealing member and a structural member supporting the sealing member, the sealing member including the sealing portion; and
wherein the structural member includes an axial portion to position the sealing portion at a predetermined axial location along the spindle nut and a radial portion extending radially inward from the axial portion to position the sealing portion at a predetermined radial location relative to the spindle nut.

4. The apparatus of claim 1 wherein the lubricant seal includes an annular structural member and a sealing member attached to the structural member;
wherein the sealing member is rubber; and
wherein the structural member is of a metallic, plastic, or composite material.

5. The apparatus of claim 1 wherein the lubricant seal includes a vent configured to open in response to air pressure on one side of the lubricant seal exceeding a predetermined threshold.

6. The apparatus of claim 1 wherein the lubricant seal comprises a structural member and a sealing layer attached to the structural member;
wherein the structural member includes a through opening radially outward of the central opening of the lubricant seal; and
wherein the sealing layer includes a valve portion aligned with the through opening of the structural member, the valve portion configured to permit air to travel through the lubricant seal.

7. The apparatus of claim 1 wherein the lubricant seal includes a resilient member having a dome portion with a slit formed therein to permit pressurized air to open the slit and travel through the lubricant seal.

8. The apparatus of claim 7 wherein the resilient member includes a ring portion concentric with the dome portion.

9. The apparatus of claim 1 wherein the sealing portion of the lubricant seal comprises a lip seal.

10. The apparatus of claim 1 wherein the sealing portion comprises an inboard surface, an outboard surface, and a juncture therebetween; and
wherein the inboard surface and outboard surface extend transversely relative to one another and are configured to create a pressure differential between an inboard side and an outboard side of the lubricant seal.

11. The apparatus of claim 1 wherein the lubricant seal includes a lip seal and a spring configured to urge the lip seal against the spindle nut.

12. The apparatus of claim 1 in combination with the spindle nut, the spindle nut comprising a rotary drive structure.

13. A wheel hub assembly comprising:
a wheel hub;
a bearing assembly for rotatably supporting the wheel hub on a vehicle spindle;
a spindle nut for securing the wheel hub and the bearing assembly to the vehicle spindle;
a running surface of the spindle nut;
a lubricant seal having a mounting portion to be secured to the wheel hub so that the lubricant seal rotates with the wheel hub; and
a sealing portion of the lubricant seal configured to sealingly engage the running surface of the spindle nut.

14. The wheel hub assembly of claim 13 wherein the running surface of the spindle nut comprises a cylindrical surface portion of the spindle nut; and
wherein the spindle nut includes a rotary drive structure adjacent the cylindrical surface portion.

15. The wheel hub assembly of claim 13 wherein the spindle nut has a flange and a rotary drive structure intermediate the running surface and the flange along the spindle nut.

16. The wheel hub assembly of claim 13 wherein the spindle nut includes a threaded nut body for engaging the spindle and a sleeve connected to the nut body, the sleeve comprising the running surface.

17. The wheel hub assembly of claim 13 wherein the lubricant seal comprises a vent configured to permit air to escape through the lubricant seal via the vent.

18. The wheel hub assembly of claim 13 further comprising a lock washer for being positioned between the spindle nut and the bearing assembly along the vehicle spindle, the lock washer having a key to engage a keyway of the vehicle spindle; and
a groove in the key of the lock washer configured to permit air to travel through the groove and into the keyway of the vehicle spindle.

19. The wheel hub assembly of claim 13 wherein the wheel hub includes an outboard end to receive a flange of a drive shaft;
wherein the wheel hub includes a groove that opens to the outboard end; and
wherein the mounting portion of the lubricant seal is configured to be received in the groove of the wheel hub and be clamped between the flange of the drive shaft and the wheel hub.

20. The wheel hub assembly of claim 13 wherein the wheel hub is rotatable around a central axis and has an inner surface extending around the central axis;
a spiral locking ring to be received in a groove of the inner surface of the wheel hub to limit movement of the spindle nut; and
wherein the mounting portion of the lubricant seal includes an annular, axial wall portion having an outer surface configured to sealingly engage the inner surface of the wheel hub and an end to abut the spiral locking ring.

21. The wheel hub assembly of claim 13 wherein the wheel hub comprises a wheel hub body and a plurality of studs connected to the wheel hub body, the studs projecting from the wheel hub body to receive a wheel.

22. A wheel hub assembly for a vehicle, the wheel hub assembly comprising:
a wheel hub having an interior;
a bearing assembly for rotatably connecting the wheel hub to a vehicle spindle of the vehicle;
a spindle nut for securing the wheel hub and the bearing assembly to the vehicle spindle;
a lubricant seal system configured to extend between a first cavity of the interior of the wheel hub that contains the bearing assembly and a second cavity of the interior of the wheel hub during operation of the vehicle;
the lubricant seal system configured to keep lubricant in the first cavity from escaping into the second cavity; and
a vent configured to relieve air pressure in the first cavity by venting air in the first cavity to the second cavity.

23. The wheel hub assembly of claim 22 wherein the lubricant seal system comprises:
a running surface of the spindle nut; and
a lubricant seal configured to be mounted to the wheel hub outboard of the bearing assembly and sealingly engage the running surface of the spindle nut.

24. The wheel hub assembly of claim 23 wherein the lubricant seal includes the vent.

25. The wheel hub assembly of claim 22 further comprising a lock washer having a key to engage a keyway of the vehicle spindle; and
wherein the vent includes at least a portion of the key of the lock washer.

26. The wheel hub assembly of claim 22 wherein the bearing assembly includes an inner cone, an outer cup, and a plurality of roller elements rotatably connecting the outer cup to the inner cone; and
wherein the vent includes at least a portion of the inner cone.

27. The wheel hub assembly of claim 22 wherein the lubricant seal system comprises an annular lubricant seal configured to be mounted to the wheel hub and rotate therewith, the lubricant seal having a central portion for sealingly engaging the spindle nut; and
wherein the vent includes at least four vents of the lubricant seal spaced about the lubricant seal so that at least one of the vents is located outside of the lubricant when the vehicle is stationary.

28. The wheel hub assembly of claim 22 wherein the lubricant seal system comprises a running surface of the spindle nut and a lubricant seal;
wherein the lubricant seal includes a sealing member configured to form a dynamic seal with the running surface of the spindle nut and a structural member to support the sealing member; and
wherein the vent includes a through opening of the structural member and a valve portion of the sealing member aligned with the through opening of the structural member.

29. The wheel hub assembly of claim 22 wherein the bearing assembly comprises an inboard bearing assembly and an outboard bearing assembly; and
a spacer having a central opening to receive the vehicle spindle, the spacer configured to maintain the relative positions of the inboard and outboard bearing assemblies along the vehicle spindle.

30. A lock washer for a wheel hub assembly, the lock washer comprising:
an annular body for being sandwiched between components of the wheel hub assembly;
a central opening of the annular body sized to receive a vehicle spindle;
a key of the annular body configured to engage a keyway of the vehicle spindle to inhibit rotation of the annular body around the vehicle spindle;
a plurality of locking openings spaced about the annular body to receive a protrusion of a lock ring; and
an air vent of the annular body configured to permit pressurized air from adjacent one of the components to travel through the air vent and into the keyway of the vehicle spindle.

31. The lock washer of claim 30 wherein the key includes an outlet of the air vent.

32. The lock washer of claim 30 wherein the key includes a radially innermost end; and
wherein the air vent opens to the radially innermost end of the key.

33. The lock washer of claim 30 wherein the air vent includes an inlet that opens to one of the locking openings; and
wherein the key includes an outlet of the air vent.

34. The lock washer of claim 30 wherein the annular body includes opposite surfaces and the locking openings extend between the opposite surfaces; and
wherein the air vent comprises a first air vent on one surface of the annular body and a second vent on the other surface of the annular body.

35. The lock washer of claim 30 wherein the annular body includes opposite surfaces and the locking openings extend between the opposite surfaces; and
wherein the air vent comprises a channel of one of the opposite surfaces.

36. The lock washer of claim 35 wherein the channel extends radially from one of the locking openings to the key of the annular body.

37. A method of installing a wheel hub on a vehicle spindle, the method comprising:
positioning a wheel hub on the vehicle spindle;
engaging a spindle nut with the vehicle spindle to rotatably capture the wheel hub on the spindle;
advancing a lubricant seal in an inboard direction in a central bore of the wheel hub to position a sealing portion of the lubricant seal in engagement with a running surface of the spindle nut; and
securing a mounting portion of the lubricant seal to the wheel hub so that the lubricant seal is rotatable with the wheel hub about the vehicle spindle while the sealing portion of the lubricant seal remains engaged with the running surface of the spindle nut.

38. The method of claim 37 wherein the lubricant seal has an annular, sealing portion extending about a central opening of the lubricant seal; and
wherein advancing the lubricant seal comprises radially deflecting the sealing portion to engage the sealing portion with the running surface of the spindle nut.

39. The method of claim 37 wherein the lubricant seal comprises a lip seal; and
wherein advancing the lubricant seal comprises engaging the lip seal with an annular running surface of the spindle nut.

40. The method of claim 37 wherein securing the mounting portion of the lubricant seal to the wheel hub comprises clamping the mounting portion between a flange of a drive shaft and the wheel hub.

41. The method of claim 37 wherein advancing the lubricant seal in the central bore of the wheel hub comprises pressing the lubricant seal into the central bore of the wheel hub; and
wherein securing the mounting portion of the lubricant seal to the wheel hub includes creating an interference fit between the mounting portion and an inner surface of the wheel hub that extends around the central bore.

42. The method of claim 37 wherein engaging the spindle nut with the vehicle spindle comprises clamping a lock washer between the spindle nut and an outboard bearing assembly; and
wherein the lock washer comprises a key having a channel that permits air to flow through the channel and into a keyway of the vehicle spindle.
